(19) United States
(12) Patent Application Publication
(10) Pub. No.: US 2019/0294659 A1
(43) Pub. Date: Sep. 26, 2019

(54) EMBEDDING A PORTION OF A SOURCE CONTENT ITEM

(71) Applicant: Dropbox, Inc., San Francisco, CA (US)

(72) Inventors: Neil Sethi, San Francisco, CA (US); Joseph Grillo, San Francisco, CA (US); Mira Rao, San Francisco, CA (US)

(21) Appl. No.: 15/926,676

(22) Filed: Mar. 20, 2018

(51) Int. Cl. G06F 17/24

(52) U.S. Cl. CPC G06F 17/24; G06F 3/04842; G06F 17/246

(57) ABSTRACT

The disclosed technology relates to a system configured to access a collaborative content item stored by a content management system and receive a user selection of a portion of a source content item to embed into the collaborative content item, wherein the source content item is managed by the content management system. The system is further configured to generate a content pane within the collaborative content item and embed the portion of the source content item in the content pane of the collaborative content item.

### BACKGROUND

Content management services allow users to access and manage content items across multiple devices using a network. Some content management services may allow users to share content items with other users in order to aid collaboration. In a typical content management service, a user establishes a content management account with the service provider and can associate various content items with the content management account. For example, content management services may allow the user to store content items (including but not limited to text documents; email messages; text messages; other types of messages; media files such as photos, videos, and audio files; and/or folders containing multiple files). Some content items may also be configured to include and/or display various items of embedded content as well.

### BRIEF DESCRIPTION OF THE DRAWINGS

The above-recited and other advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1A shows an example of a content management system and client devices, in accordance with some embodiments;

FIG. 1B shows an example collaboration service, in accordance with some embodiments;

FIG. 2 shows an example graphical user interface displaying a content item managed by a content management system, in accordance with various embodiments of the subject technology;

FIGS. 3-5 show example graphical user interfaces that help to illustrate various embodiments of the subject technology;

FIG. 6 illustrates an example method for embedding a portion of a source content item in a collaborative content item, in accordance with various embodiments of the subject technology;

FIG. 7 illustrates an example method for editing a source content item embedded in a collaborative content item, in accordance with various embodiments of the subject technology;

FIG. 8 illustrates an example method for updating a source content item embedded in a collaborative content item, in accordance with various embodiments of the subject technology; and

FIG. 9 shows an example of a system for implementing certain aspects of the present technology.

### DETAILED DESCRIPTION

Various examples of the present technology are discussed in detail below. While specific implementations are discussed, it should be understood that this is done for illustration purposes only. A person skilled in the relevant art will recognize that other components and configurations may be used without parting from the spirit and scope of the present technology.

A collaborative content management system may allow for sharing of one or more collaborative content items among various users. Each user may access the one or more content items and use the collaborative content items to collaborate. Generally, the collaborative content management system may allow for the embedding of various content items within a collaborative content item. For example, images, spreadsheets, links to web resources, videos, audio files, word processing documents, or other content items may be embedded within a collaborative content item.

In some cases, these embedded content items are encoded or configured to be displayed in a certain manner. For example, an entire content item is embedded within a collaborative content item and the embedded content item may be displayed in the collaborative content item as a text link that can be used to access the embedded content, an icon representing the embedded content item that can be used to access the embedded content, or the collaborative content management system may be programmed to display embedded content item in the collaborative content item in some predefined way. For example, an image may be displayed in the collaborative content item in its entirety, the first sheet of a spreadsheet content item may be displayed in its entirety, or a first slide of a slide deck or other presentation content item may be displayed in its entirety.

However, the manner in which an embedded content item is displayed in a collaborative content item is largely system defined. For example, each type of content item may be embedded in a collaborative content item in a certain manner that is specified and encoded by the collaborative content management system. Very little customization or control is provided to the user. This may reduce the usefulness and limit collaborative functionality of some collaborative content items.

The disclosed technology addresses the need in the art for providing users with more fine-grained control over what content is embedded and how the embedded content is displayed in a collaborative content item. For example, aspects of the subject technology provide an interface that allows a user to select one or more portions of a source content item to embed and/or display in a collaborative content item. As a result, a user may limit what portion(s) of the source content item are displayed in the collaborative content item to the most pertinent and relevant portion(s). As a result, collaboration and engagement with other users may be more focused and less distracted by less relevant portions of the source content item. This also allows the user who made the selection to be able to more clearly articulate an intended message and make more effective use of limited space.

Although various aspects of the subject technology relate to collaborative content items that may be shared and accessed by multiple users, some embodiments may similarly apply to other types of content items managed by, for example, a content management system.

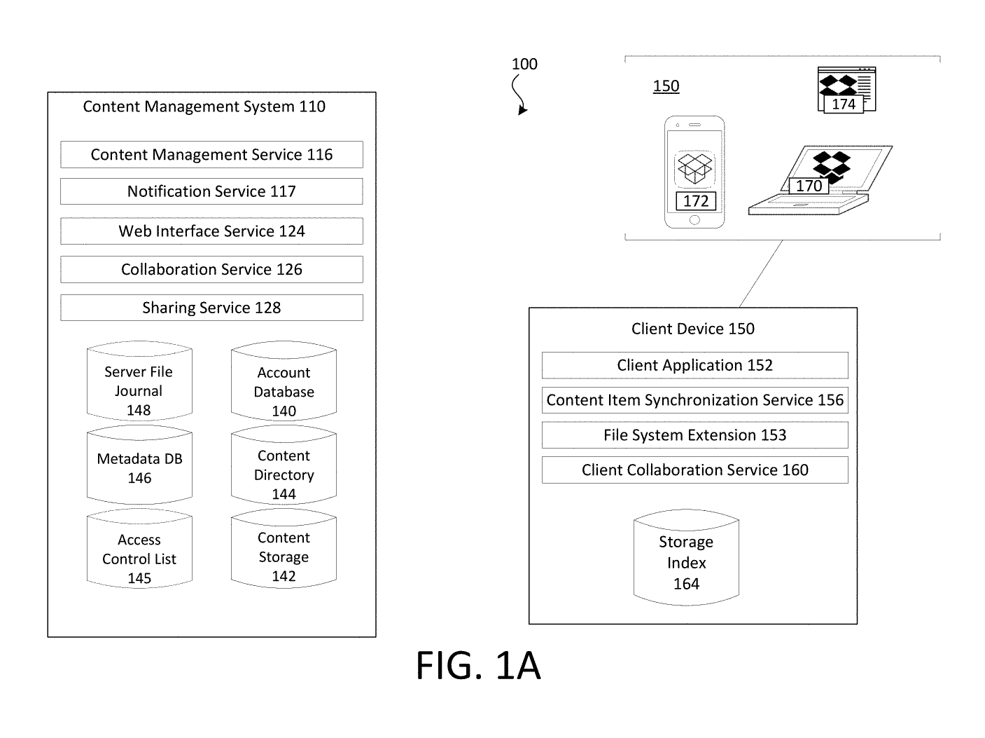

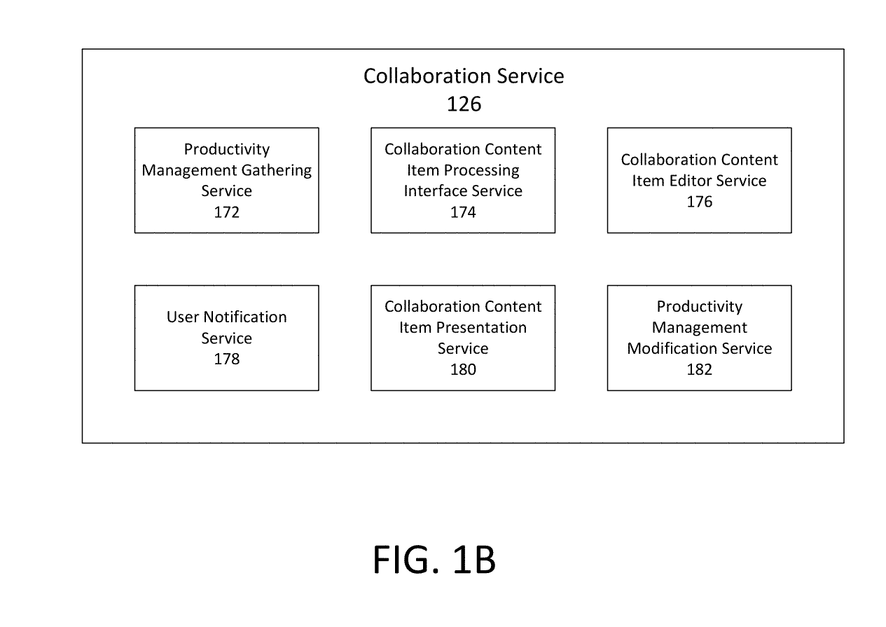

In some embodiments, the disclosed technology is deployed in the context of a content management system having content item synchronization capabilities and collaboration features, among others. An example system configuration 100 is shown in FIG. 1A, which depicts content management system 110 interacting with client device 150.

Accounts

Content management system 110 can store content items in association with accounts, as well as perform a variety of content item management tasks, such as retrieve, modify, browse, and/or share the content item(s). Furthermore, content management system 110 can enable an account to access content item(s) from multiple client devices.

Content management system 110 supports a plurality of accounts. An entity (user, group of users, company, etc.) can create an account with content management system, and account details can be stored in account database 140. Account database 140 can store profile information for registered entities. In some cases, profile information for registered entities includes a username and/or email address. Account database 140 can include account management information, such as account type (e.g. various tiers of free or paid accounts), storage space allocated, storage space used, client devices 150 having a registered content management client application 152 resident thereon, security settings, personal configuration settings, etc.

Account database 140 can store groups of accounts associated with an entity. Groups can have permissions based on group policies and/or access control lists, and members of the groups can inherit the permissions. For example, a marketing group can have access to one set of content items while an engineering group can have access to another set of content items. An administrator group can modify groups, modify user accounts, etc.

Content Item Storage

A feature of content management system 110 is the storage of content items, which can be stored in content storage 142. Content items can be any digital data such as documents, collaborative content items, text files, audio files, image files, video files, webpages, executable files, binary files, etc. A content item can also include collections or other mechanisms for grouping content items together with different behaviors, such as folders, zip files, playlists, albums, etc. A collection can refer to a folder, or a plurality of content items that are related or grouped by a common attribute. In some embodiments, content storage 142 is combined with other types of storage or databases to handle specific functions. Content storage 142 can store content items, while metadata regarding the content items can be stored in metadata database 146. Likewise, data regarding where a content item is stored in content storage 142 can be stored in content directory 144. Additionally, data regarding changes, access, etc. can be stored in server file journal 148. Each of the various storages/databases such as content storage 142, content directory 144, server file journal 148, and metadata database 146 can be comprised of more than one such storage or database and can be distributed over many devices and locations. Other configurations are also possible. For example, data from content storage 142, content directory 144, server file journal 148, and/or metadata database 146 may be combined into one or more content storages or databases or further segmented into additional content storages or databases. Thus, content management system 110 may include more or less storages and/or databases than shown in FIG. 1A.

In some embodiments, content storage 142 is associated with at least one content management service 116, which includes software or other processor executable instructions for managing the storage of content items including, but not limited to, receiving content items for storage, preparing content items for storage, selecting a storage location for the content item, retrieving content items from storage, etc. In some embodiments, content management service 116 can divide a content item into smaller chunks for storage at content storage 142. The location of each chunk making up a content item can be recorded in content directory 144. Content directory 144 can include a content entry for each content item stored in content storage 142. The content entry can be associated with a unique ID, which identifies a content item.

In some embodiments, the unique ID, which identifies a content item in content directory 144, can be derived from a deterministic hash function. This method of deriving a unique ID for a content item can ensure that content item duplicates are recognized as such since the deterministic hash function will output the same identifier for every copy of the same content item, but will output a different identifier for a different content item. Using this methodology, content management service 116 can output a unique ID for each content item.

Content management service 116 can also designate or record a content path for a content item. The content path can include the name of the content item and/or folder hierarchy associated with the content item. For example, the content path can include a folder or path of folders in which the content item is stored in a local file system on a client device. Content management service 116 can use the content path to present the content items in the appropriate folder hierarchy, such as a tree-like directory structure. While content items are stored in content storage 142 in blocks and may not be stored under a tree like directory structure, such directory structure is a comfortable navigation structure for users. Content management service 116 can define or record a content path for a content item wherein the “root” node of a directory structure can be a namespace for each account. Within the namespace can be a directory structure defined by a user of an account and/or content management service 116. Content directory 144 can store the content path for each content item as part of a content entry.

In some embodiments the namespace can include additional namespaces that appear in the directory structure as if they are stored within the root node. This can occur when an account has access to a shared collection. Shared collections can be assigned their own namespace within content management system 110. While shared collections are actually a root node for the shared collection, they are located subordinate to the user account namespace in the directory structure, and can appear as a folder within a folder for the user account. As addressed above, the directory structure is merely a comfortable navigation structure for users, but does not correlate to storage locations of content items in content storage 142.

While the directory structure in which an account views content items does not correlate to storage locations at content management system 110, the directory structure can correlate to storage locations on client device 150 depending on the file system used by client device 150.

As addressed above, a content entry in content directory 144 can also include the location of each chunk making up a content item. More specifically, the content entry can include content pointers that identify the location in content storage 142 of the chunks that make up the content item.

In addition to a content path and content pointer, a content entry in content directory 144 can also include a user account identifier that identifies the user account that has access to the content item and/or a group identifier that identifies a group with access to the content item. In some embodiments, multiple user account identifiers can be associated with a single content entry indicating that the content item has shared access by the multiple user accounts. In some embodiments, user account identifiers associated with a single content entry can specify different permissions for the associated content item. In some embodiments, content directory 144 can describe a hierarchical structure of content items associated with a user account, the hierarchical structure being specific to the user account.

Content management service 116 can decrease the amount of storage space required by identifying duplicate content items or duplicate blocks that make up a content item or versions of a content item. Instead of storing multiple copies, content storage 142 can store a single copy of the content item or block of the content item and content directory 144 can include a pointer or other mechanism to link the duplicates to the single copy.

Content management service 116 can also store metadata describing content items, content item types, folders, file path, and/or the relationship of content items to various accounts, collections, or groups in metadata database 146, in association with the unique ID of the content item.

Content management service 116 can also store a log of data regarding changes, access, etc. in server file journal 148. Server file journal 148 can include the unique ID of the content item and a description of the change or access action along with a time stamp or version number and any other relevant data. Server file journal 148 can also include pointers to blocks affected by the change or content item access. Content management service can provide the ability to undo operations, by using a content item version control that tracks changes to content items, different versions of content items (including diverging version trees), and a change history that can be acquired from the server file journal 148. The change history can include a set of changes that, when applied to the original content item version, produce the changed content item version.

Content Item Synchronization

Another feature of content management system 110 is synchronization of content items with at least one client device 150. Client device(s) can take different forms and have different capabilities. For example, client device 170 is a computing device having a local file system accessible by multiple applications resident thereon. Client device 172 is a computing device wherein content items are only accessible to a specific application or by permission given by the specific application, and the content items are stored either in an application specific space or in the cloud. Client device 174 is any client device accessing content management system 110 via a web browser and accessing content items via a web interface. While example client devices 170, 172, and 174 are depicted in form factors such as a laptop, mobile device, or web browser, it should be understood that the descriptions thereof are not limited to devices of these example form factors. For example a mobile device such as client 172 might have a local file system accessible by multiple applications resident thereon, or client 172 might access content management system 110 via a web browser. As such, the form factor should not be considered limiting when considering client 150's capabilities. One or more functions described herein with respect to client device 150 may or may not be available on every client device depending on the specific capabilities of the device—the file access model being one such capability.

In many embodiments, client devices are associated with an account of content management system 110, but in some embodiments client devices can access content using shared links and do not require an account.

As noted above, some client devices can access content management system 110 using a web browser. However, client devices can also access content management system 110 using client application 152 stored and running on client device 150. Client application 152 can include a content item synchronization service 156.

Content item synchronization service 156 can be in communication with content management service 116 to synchronize changes to content items between client device 150 and content management system 110.

Client device 150 can synchronize content with content management system 110 via content synchronization service 156. The synchronization can be platform agnostic. That is, content can be synchronized across multiple client devices of varying type, capabilities, operating systems, etc. Content synchronization service 156 can synchronize any changes (new, deleted, modified, copied, or moved content items) to content items in a designated location of a file system of client device 150.

Content items can be synchronized from client device 150 to content management system 110, and vice versa. In embodiments wherein synchronization is from client device 150 to content management system 110, a user can manipulate content items directly from the file system of client device 150, while file system extension 153 (which can be integrated with the local file system, or even the operating system kernel) can intercept read, write, copy, move, and delete commands relative to content items in the designated location of the file system of client device 150.

When file system extension 153 notices a write, move, copy, or delete command, it can notify content item synchronization service 156, which can synchronize the changes to content management system service 116. In some embodiments, content item synchronization service 156 can perform some functions of content management system service 116 including functions addressed above such as dividing the content item into blocks, hashing the content item to generate a unique identifier, etc. Content synchronization service 156 can index content within client storage index 164 and save the result in storage index 164. Indexing can include creating a unique identifier for each content item. In some embodiments, content synchronization service 156 creates this unique identifier by putting the data of the content item (e.g., excluding the filename and/or other metadata) through a hash function; as addressed above, content management system can use a similar process to provide identifiers to content on content management system 110. Content synchronization service 156 can use storage index 164 to facilitate the synchronization of at least a portion of the content within client storage with content associated with a user account on content management system 110. For example, content synchronization service 156 can compare storage index 164 with content management system 110 and detect differences between content on client storage and content associated with a user account on content management system 110. Content synchronization service 156 can then attempt to reconcile differences by uploading, downloading, modifying, and deleting content on client storage as appropriate. Content management service 116 can store the changed or new block for the content item and update server file journal 148, metadata database 146, content directory 144, content storage 142, account database 140, etc. as appropriate.

When synchronizing from content management system 110 to client device 150, a modification, addition, deletion, or move of a content item recorded in server file journal 148 can trigger a notification to be sent to client device 150 using notification service 117. When client device 150 is informed of the change to server file journal 148, client device can check storage index 164 to determine if the time stamp of the change occurred since the last synchronization, or determine if the specific change has been synchronized. When client device 150 determines that it is out of synchronization with content management system 110, content item synchronization service 156 requests content item blocks including the changes, and updates its local copy of the changed content items. In some embodiments, notification service can query other services or databases of content management system 110 such as server file journal 148 to gain more context for the notification, to determine if a notification can be batched with another notification or to supplement a notification

Sometimes client device 150 might not have a network connection available. In this scenario, content item synchronization service 156 can monitor the linked collection for content item changes and queue those changes for later synchronization to content management system 110 when a network connection is available. Similarly, a user can manually start, stop, pause, or resume synchronization with content management system 110.

Content item synchronization service 156 can synchronize all content associated with a particular user account on content management system 110. Alternatively, content item synchronization service 156 can selectively synchronize a portion of the content of the total content associated with the particular user account on content management system 110. Selectively synchronizing only a portion of the content can preserve space on client device 150 and save bandwidth.

In some embodiments, content item synchronization service 156 selectively stores a portion of the content associated with the particular user account and stores placeholder content items in client storage for the remainder portion of the content. For example, content item synchronization service 156 can store a placeholder content item that has the same filename, path, extension, metadata, of its respective complete content item on content management system 110, but lacking the data of the complete content item. The placeholder content item can be a few kilobytes or less in size while the respective complete content item might be significantly larger. After client device 150 attempts to access the content item, content item synchronization service 156 can retrieve the data of the content item from content management system 110 and provide the complete content item to accessing client device 150. This approach can provide significant space and bandwidth savings while still providing full access to a user's content on content management system 110.

Collaboration Features

Another feature of content management system 110 is to facilitate collaboration between users. Collaboration features include content item sharing, commenting on content items, co-working on content items, instant messaging, providing presence and seen state information regarding content items, etc.

Sharing

Content management system 110 can manage sharing content via sharing service 128. Sharing content by providing a link to the content can include making the content item accessible from any computing device in network communication with content management system 110. However, in some embodiments a link can be associated with access restrictions enforced by content management system 110. Sharing content can also include linking content using sharing service 128 to share content within content management system 110 with at least one additional user account (in addition to the original user account associated with the content item) so that each user account has access to the content item. The additional user account can gain access to the content by accepting the content, which will then be accessible through either web interface service 124 or directly from within the directory structure associated with their account on client device 150. The sharing can be performed in a platform agnostic manner. That is, the content can be shared across multiple client devices 150 of varying type, capabilities, operating systems, etc. The content can also be shared across varying types of user accounts.

To share a content item within content management system 110 sharing service 128 can add a user account identifier to a content entry in access control list database 145 associated with the content item, thus granting the added user account access to the content item. Sharing service 128 can also remove user account identifiers from a content entry to restrict a user account's access to the content item. Sharing service 128 can record content item identifiers, user account identifiers given access to a content item, and access levels in access control list database 145.

To share content items outside of content management system 110, sharing service 128 can generate a custom network address, such as a uniform resource locator (URL), which allows any web browser to access the content item or collection in content management system 110 without any authentication. To accomplish this, sharing service 128 can include content identification data in the generated URL, which can later be used to properly identify and return the requested content item. For example, sharing service 128 can include the account identifier and the content path or a content item identifying code in the generated URL. Upon selection of the URL, the content identification data included in the URL can be transmitted to content management system 110, which can use the received content identification data to identify the appropriate content item and return the content item.

In addition to generating the URL, sharing service 128 can also be configured to record in access control list database 145 that a URL to the content item has been created. In some embodiments, the content entry associated with a content item can include a URL flag indicating whether a URL to the content item has been created. For example, the URL flag can be a Boolean value initially set to 0 or false to indicate that a URL to the content item has not been created. Sharing service 128 can change the value of the flag to 1 or true after generating a URL to the content item.

In some embodiments, sharing service 128 can associate a set of permissions to a URL for a content item. For example, if a user attempts to access the content item via the URL, sharing service 128 can provide a limited set of permissions for the content item. Examples of limited permissions include restrictions that the user cannot download the content item, save the content item, copy the content item, modify the content item, etc. In some embodiments, limited permissions include restrictions that only permit a content item to be accessed from with a specified domain, i.e., from within a corporate network domain, or by accounts associated with a specified domain, e.g., accounts associated with a company account (e.g., @acme.com).

In some embodiments, sharing service 128 can also be configured to deactivate a generated URL. For example, each content entry can also include a URL active flag indicating whether the content should be returned in response to a request from the generated URL. For example, sharing service 128 can only return a content item requested by a generated link if the URL active flag is set to 1 or true. Thus, access to a content item for which a URL has been generated can be easily restricted by changing the value of the URL active flag. This allows a user to restrict access to the shared content item without having to move the content item or delete the generated URL. Likewise, sharing service 128 can reactivate the URL by again changing the value of the URL active flag to 1 or true. A user can thus easily restore access to the content item without the need to generate a new URL.

In some embodiments, content management system 110 can designate a URL for uploading a content item. For example, a first user with a user account can request such a URL, provide the URL to a contributing user and the contributing user can upload a content item to the first user's user account using the URL.

Presence and Seen State

In some embodiments, content management system can provide information about how users with which a content item is shared are interacting or have interacted with the content item. In some embodiments, content management system 110 can report that a user with which a content item is shared is currently viewing the content item. For example, client collaboration service 160 can notify notifications service 117 when client device 150 is accessing the content item. Notifications service 117 can then notify all client devices of other users having access to the same content item of the presence of the user of client device 150 with respect to the content item.

In some embodiments, content management system 110 can report a history of user interaction with a shared content item. Collaboration service 126 can query data sources such as metadata database 146 and server file journal 148 to determine that a user has saved the content item, that a user has yet to view the content item, etc., and disseminate this status information using notification service 117 to other users so that they can know who currently is or has viewed or modified the content item.

Collaboration service 126 can facilitate comments associated with content, even if a content item does not natively support commenting functionality. Such comments can be stored in metadata database 146. Collaboration service 126 can originate and transmit notifications for users. For example, a user can mention another user in a comment and collaboration service 126 can send a notification to that user that he has been mentioned in the comment. Various other content item events can trigger notifications, including deleting a content item, sharing a content item, etc. Collaboration service 126 can provide a messaging platform whereby users can send and receive instant messages, voice calls, emails, etc.

Although some embodiment discussed herein may refer to a content management system 110 or a collaborative content management system, these systems may be interchangeable. For example, a collaborative content management system may be a content management system that includes a collaboration service such as content management system 110 in FIG. 1A.

Collaborative Content Items

Collaboration service 126 can also provide an interactive content item collaboration platform whereby users can simultaneously create collaborative content items, comment in the collaborative content items, and manage tasks within the collaborative content items. Collaborative content items can be files that users can create and edit using a collaborative content item editor, and can contain collaborative content item elements. Collaborative content item elements may include a collaborative content item identifier, one or more author identifiers, collaborative content item text, collaborative content item attributes, interaction information, comments, sharing users, etc. Collaborative content item elements can be stored as database entities, which allows for searching and retrieving the collaborative content items. Multiple users may access, view, edit, and collaborate on collaborative content items at the same time or at different times. In some embodiments this can be managed by enabling two or more users to access a content item through a web interface or application interface and there they can work on the same copy of the content item at the same time.

Collaboration Companion Interface

In some embodiments client collaboration service 160 can provide a native application companion interface for the purpose of displaying information relevant to a content item being presented on client device 150. In embodiments wherein a content item is accessed by a native application stored and executed on client device 150, where the content item is in a designated location of the file system of client device 150 such that the content item is managed by content application 152, the native application may not provide any native way to display the above addressed collaboration data. In such embodiments, client collaboration service 160 can detect that a user has opened a content item, and can provide an overlay with additional information for the content item, such as collaboration data. For example, the additional information can include comments for the content item, status of the content item, activity of other users previously or currently viewing the content item. Such an overlay can warn a user that changes might be lost because another user is currently editing the content item.

In some embodiments, one or more of the services or storages/databases discussed above can be accessed using public or private application programming interfaces.

Certain software applications can access content storage 142 via an API on behalf of a user. For example, a software package such as an application running on client device 150, can programmatically make API calls directly to content management system 110 when a user provides authentication credentials, to read, write, create, delete, share, or otherwise manipulate content.

A user can view or manipulate content stored in a user account via a web interface generated and served by web interface service 124. For example, the user can navigate in a web browser to a web address provided by content management system 110. Changes or updates to content in the content storage 142 made through the web interface, such as uploading a new version of a content item, can be propagated back to other client devices associated with the user's account. For example, multiple client devices, each with their own client software, can be associated with a single account and content items in the account can be synchronized between each of the multiple client devices.

Client device 150 can connect to content management system 110 on behalf of a user. A user can directly interact with client device 150, for example when client device 150 is a desktop or laptop computer, phone, television, internet-of-things device, etc. Alternatively or additionally, client device 150 can act on behalf of the user without the user having physical access to client device 150, for example when client device 150 is a server.

Some features of client device 150 are enabled by an application installed on client device 150. In some embodiments, the application can include a content management system specific component. For example, the content management system specific component can be a stand-alone application 152, one or more application plug-ins, and/or a browser extension. However, the user can also interact with content management system 110 via a third-party application, such as a web browser, that resides on client device 150 and is configured to communicate with content management system 110. In various implementations, the client-side application 152 can present a user interface (UI) for a user to interact with content management system 110. For example, the user can interact with the content management system 110 via file system extension 153 integrated with the file system or via a webpage displayed using a web browser application.

In some embodiments, client application 152 can be configured to manage and synchronize content for more than one account of content management system 110. In such embodiments client application 152 can remain logged into multiple accounts and provide normal services for the multiple accounts. In some embodiments, each account can appear as a folder in a file system, and all content items within that folder can be synchronized with content management system 110. In some embodiments, client application 152 can include a selector to choose one of the multiple accounts to be the primary account or default account.

While content management system 110 is presented with specific components, it should be understood by one skilled in the art, that the architectural configuration of system 100 is simply one possible configuration and that other configurations with more or fewer components are possible. Further, a service can have more or less functionality, even including functionality described as being with another service. Moreover, features described herein with respect to an embodiment can be combined with features described with respect to another embodiment.

While system 100 is presented with specific components, it should be understood by one skilled in the art, that the architectural configuration of system 100 is simply one possible configuration and that other configurations with more or fewer components are possible.

FIG. 1B shows an example collaboration service 126, according to some embodiments. Collaboration service 126 may include productivity management gathering service 172, collaborative content item processing interface service 174, collaborative content item editor service 176, user notification service 178, collaborative content item presentation service 180, and productivity management modification service 182. One or more of productivity management gathering service 172, collaborative content item processing interface service 174, collaborative content item editor service 176, user notification service 178, collaborative content item presentation service 180, and productivity management modification service 182 may be coupled to one another or to services not explicitly shown.

Productivity management gathering service 172 may be configured to gather productivity data from productivity management system 140. In various embodiments, productivity management gathering service 172 identifies an event and gathers information related to the event. For instance, productivity management gathering service 172 may gather a specific calendar entry and/or a specific task from an online calendar. Productivity management gathering service 172 may further gather information from the calendar entry or gather information related to the calendar entry such as time(s), date(s), relevant locations, title(s), agenda(s), summaries, description(s), and/or attendees related to the event. Productivity management gathering module 172 may provide the productivity data to the other services of collaboration service 126.

Collaborative content item processing interface service 174 may be configured to interface with collaboration service 126. In various embodiments, collaborative content item processing interface service 174 may provide collaborative content items to one or more services of collaboration service 126, as described further herein.

Collaborative content item editor service 176 may be configured to create and/or modify collaborative content items. A collaborative content item may be created in a variety of ways. In some embodiments, collaborative content item editor service 176 enables creation of the collaborative content item into the content management system 106. Collaborative content item editor service 176 may enable access to or be any collaborative content item editing application (e.g., Microsoft Word®, Google Docs®, or the like) either in the cloud or executed locally. In one example, content management system 106 may provide to one of client devices 102 a user interface element (e.g., a box or a button) that allows creation of a new collaborative content item.

In some embodiments, collaborative content item editor service 176 may create the collaborative content item in conjunction with the productivity management system 140. For example, collaborative content item editor service 176 may provide a suggestion to a user to create or invoke a collaborative content item associated with an upcoming event. In various embodiments, collaboration service 126 may identify a user that is opening or otherwise using collaborative content item editor service 176. Productivity management gathering service 172 may identify an upcoming event for the user on the user's calendar. Subsequently, collaborative content item editor service 176 may provide a suggestion to the user to create or invoke the collaborative content item associated with the upcoming event.

Although it is discussed that collaborative content item editor service 176 may provide a suggestion to the user to create or invoke the collaborative content item associated with the upcoming event, it will be appreciated that the suggestion to create or invoke the collaborative content item may be made by any application. For example, a user may log into and/or otherwise access any application or suite of applications. Once the user is identified and an upcoming event is identified on the user's calendar, any application may provide the user with the suggestion to create or invoke the collaborative content item associated with the upcoming event. The suggestion may be provided to the user in any number of ways. In one example, an application suite management system (e.g., managing a variety of different applications) may provide the suggestion in a notification section of a window. In another example, a workspace may include the suggestion to the user in a section dedicated to notifications. In a further example, an email program may generate an email containing the suggestion to the user.

If the user requests creation or invocation of the collaborative content item in response to the suggestion, collaborative content item editor service 176 may create or invoke the requested collaborative content item. If the application that provided the suggestion to the user is not a collaborative content item editor, then a collaborative content item editor may be executed and the requested collaborative content item created and/or invoked in response to the user's request.

In accordance with some embodiments, collaborative content item editor service 176 may configure the productivity management system 140 to provide access to the collaborative content item (e.g., using a link, including the collaborative content item, or any other mechanism to enable access to the collaborative content item) in a meeting request, a task entry, or the like. In some embodiments, collaborative content item editor service 176 may instruct productivity management system 140 to place an icon corresponding to a link to the collaborative content item in the calendar entry, meeting request, task entry, or the like. When a user has opened the link (e.g., by clicking the icon), the user may be directly guided to the collaborative content item from the meeting request, task entry, or the like. In one example, the link in the calendar entry may provide the user (e.g., using client device 102) access to a collaborative content item stored in content management system 106 (e.g., in storage accessible through the cloud) or in productivity management system 140.

Once the user requests to create or invoke the collaborative content item, collaborative content item editor service 176 may create and/or invoke a collaborative content item. The collaborative content item may be subsequently edited, altered, viewed, changed, stored, and/or the like by an editing application (e.g., either stored locally on a client device 102 or in the cloud). In various embodiments, one or more different client devices 102 may utilize different editing applications to make changes to the collaborative content item. Collaborative content item editor service 176 and/or other editing applications may allow for the collaborative content item to be changed by multiple different users using different client devices 102 at the same time or substantially at the same time (e.g., in real time or substantially in real time).

It will be appreciated that users may be automatically guided to a collaborative content item related to a calendar entry, meeting request, a task entry, or the like without human intervention. In some embodiments, users may be guided to a collaborative content item related to a calendar entry, a meeting request, a task entry, or the like without having the users separately open collaborative content item editing applications. Such functionalities may prove particularly convenient for users seeking to take, review, or collaborate on notes associated with an event, as these users need not open applications other than productivity management applications.

Collaborative content item editor service 176 may receive from users additional content for the collaborative content item. For example, collaborative content item editor service 176 may be configured to receive from the client devices 102 changes or edits to the collaborative content item. In various embodiments, the changes may include text, characters strings, or the like. The changes may also include annotations to the collaborative content item, comments to the collaborative content item, files to be attached to the collaborative content item, pictures to be attached to the collaborative content item, links to be attached to the collaborative content item, tasks related to the collaborative content item, or the like that can be incorporated into the collaborative content item. In various embodiments, edits to the collaborative content item are collaboration. For instance, collaborative content item editor service 176 may obtain edits (e.g., text changes and/or additions of audio files, pictures, tables, or the like) from any number of client devices 102 at a given time (or in real time). Collaboration edits may be incorporated in a variety of formats, including formats that provide different text attributes such as colors, fonts, styles, or the like for different users.

In various embodiments, collaborative content item editor service 176 (and or a security or permissions service associated with a server) may establish permissions and/or security for the collaborative content item. For example, collaborative content item editor service 176 may enable event attendees to view and/or make edits to the collaborative content item while others may not have rights to view the collaborative content items and/or make changes. Permissions and/or security may be enforced in any number of ways. However, access to the collaborative content item may, in various embodiments, be provided to attendees of the event or a subset of attendees.

In some implementations, users can enter commands by providing pre-established primitives. A primitive can be a specified sequence of one or more characters that the content management system 106 recognizes as mapped to particular functionality. In some implementations, a primitive can be followed by one or more parameters specifying how the system should implement the corresponding functionality. Examples of primitives include a user identification primitive (e.g., “@” followed by a username parameter—referred to herein as a mention of a user), a task creation primitive (e.g., “[ ]” followed by a task title parameter), an emoji selector primitive (e.g., “:”), a content item selector and reference insertion primitive (e.g., “+” followed by at contentItem title parameter), a bullet list primitive (e.g., “*”), etc. Primitive parameters can define the corresponding functionality in various ways. For example, the + primitive can operate by taking the content specified by a contentItemTitle parameter and attempting to match it to an existing content item. In some implementations, when such a match is found, the primitive, and any associated parameter, can be replaced in the collaborative content item with a reference to the content item, such as a URL. Such a reference, when activated, can load the referenced collaborative content item. In some implementations, a primitive can take another primitive as a parameter. For example, the content “[ ] @kingHenry” can be interpreted such that @kingHenry links to a user with the username “kingHenry,” and this link is used by the primitive “[ ]” to creates a new task, where that task is assigned to the kingHenry user.

In various embodiments, collaborative content item editor service 176 (and or a security or permissions service associated with a server) may establish permissions and/or security for the collaborative content item. For example, collaborative content item editor service 176 may enable event attendees to view and/or make edits to the collaborative content item while others may not have rights to view the collaborative content items and/or make changes. Permissions and/or security may be enforced in any number of ways. However, access to the collaborative content item may, in various embodiments, be provided to attendees of the event or a subset of attendees.

In various embodiments, access to the collaborative content item is limited based on storage access rights. For example, a user with access rights to cloud storage may access, view, and/or make changes to the collaborative content item. In some embodiments, a user with access rights assigned by the content management system 106 may access, view, and/or make changes to the collaborative content item.

User notification service 178 may be configured to notify users of each of the client devices 102 of information related to the state and/or contents of the collaborative content item. Notifications may be sent, for example as an email notification, a chat message notification, a notification in a display of the collaborative content item, or in relation to the collaborative content item through a file system or other organizational system. In various embodiments, user notification service 178 provides notifications about changes to the client devices 102. For example, user notification service 178 may notify users whether a collaborative content item has been created for an event. As another example, user notification service 178 may notify specific users that they have been invited to attend an event.

Collaborative content item presentation service 180 may provide to the client devices 102 selected collaborative content items. The collaborative content items may be displayed in the client devices 102 through a native application, an Internet browsing window, or the like supported by the client devices 102.

It will be appreciated that collaborative content item presentation service 180 may restrict writing permissions to the collaborative content items at any time. In an example, prior to occurrence of the event, collaborative content item presentation service 180 may restrict writing permissions to the collaborative content item (and turn the collaborative content item into a read-only collaborative content item) for all users except the creator or invoker of the collaborative content item. In some embodiments, the creator or invoker of the collaborative content item may select a subset of recipients to receive writing permissions.

Collaborative content item presentation service 180 may also support a collaborative content item viewing portal users can use to view existing collaborative content items. The collaborative content item viewing portal may order specific collaborative content items based on one or more ordering factors. “Ordering factors,” as used herein, may include any factors used to order collaborative content items. Ordering factors can include factors used to order collaborative content items chronologically. More specifically, in some embodiments, the collaborative content item viewing portal orders collaborative content items according to the date(s) and/or times the collaborative content items were created. The collaborative content item viewing portal may also order collaborative content items according to the date(s) and/or time(s) the collaborative content items were edited. In various embodiments, the collaborative content item viewing portal orders collaborative content items according to the date(s) and/or time(s) of corresponding events to which the collaborative content items were related. Ordering factors can also include factors used to order collaborative content items according to the preferences of a specific user, such as whether the user has accepted events to which the collaborative content items were related.

In some embodiments, a collaborative content item viewing portal may be dedicated to a particular user who has received access to the collaborative content item because the particular user was related to an event. The user's collaborative content item viewing portal may provide access to any number of collaborative content items including the collaborative content item. The collaborative content items represented in the collaborative content item viewing portal may be ordered in any number of ways. For example, the collaborative content item viewing portal may order collaborative content items based on date and time of corresponding events.

The collaborative content item viewing portal may support search functions. For instance, the collaborative content item viewing portal may enable or allow searching for collaborative content items according to textual strings, titles, event attendees, and/or other attributes. The search functions may allow a specific user to search one or more collaborative content items for that user or for other users.

In some embodiments, productivity management modification service 182 may be configured to coordinate collaborative content items with calendar entries and to enable access to the collaborative content item through calendar entries.

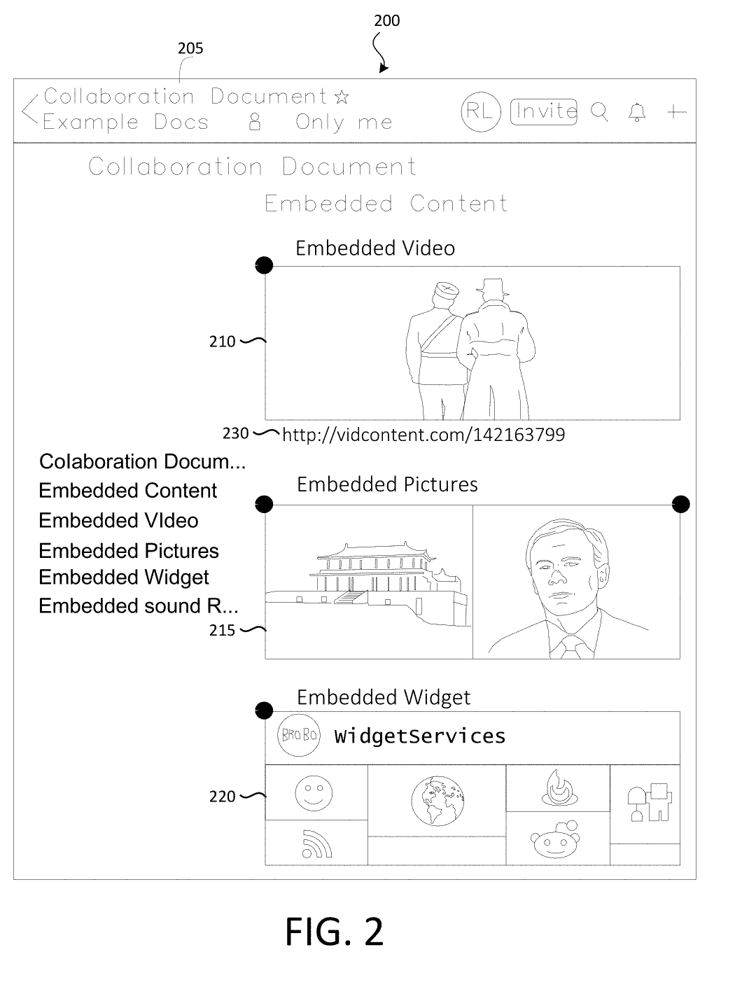

FIG. 2 shows an example graphical user interface 200 displaying a content item managed by a content management system, in accordance with various embodiments of the subject technology. The graphical user interface 200 may be provided by a client application (e.g., a web browser or native application) running on a client device. The client application may be configured to interface with the content management system to retrieve and display a content item stored or managed by the content management system. In FIG. 2, the content item is in the form of collaborative content item 205. However, other types of content items (e.g., other types of files) may also be presented to the user.

The content management system may enable other content items to be embedded in the collaborative content item 205. For example, a user may use the graphical user interface 200 to embed another content item (e.g., spreadsheet, a picture, a video, a document, an audio file, a file, or a web resource) stored on the local client device into the collaborative content item 205. The user may also use the graphical user interface 200 to embed content items stored elsewhere such as on the content management system or some other content providing service (e.g., a content platform). In FIG. 2, the collaborative content item includes an embedded video 210, embedded pictures 215, and an embedded widget 220. As seen in FIG. 210, the embedded video 210 is a content item stored at a remote content provider that is accessible via an internet URL 230. The other embedded content items may be similarly accessed via a remote content provider or locally at the client device.

The client application working with the content management system may execute code that facilitates the embedding of content items. For example, a user may embed embedded video 210 in FIG. 2 by simply inserting the URL 230 for a video stored on a remote content providing service. In response to receiving the URL 230 in the collaborative content item 205, code executed by the client application and/or the content management system may determine, based on the URL 230, the kind of content that is to be embedded in the collaborative content item 205, locate the content via the URL 230, retrieve the content, and embed the content into the collaborative content item 205. Alternatively, a user may embed content by using an interface element provided by user interface 200 to embed content into the collaborative content item 205.

Aspects of the subject technology provide the user to customize and configure how content is displayed and/or embedded in the collaborative content item 205. For example, the user interface 200 may include one or more interface elements that enable a user to select for display a portion of the content that is embedded in the collaborative content item 205 or that is to be embedded in the collaborative content item.

The selected portion of the content may be defined by, for example, location data or a selection of one or more units when the content item is made of a number of units. For example, in a spreadsheet content item, the user may select one or more cells, a range of cells, sheets in the spreadsheet, or a combination thereof. For an image content item or a video content item, the user may crop one or more portions of the image, where the crop(s) may be defined by pixel locations, coordinates, ranges, or other location data in the image. In some embodiments, an image or video content item may be masked instead of cropped, whereby a larger portion of the content item is embedded and accessible via the collaborative content item but only the selected portion of the content item is visible through a content pane or window. For video content items and audio content items, the user may select start and stop times. For a slideshow or presentation content item, the user may select one or more slides. The system may also enable the selection of other units of content for various other types of content items that include a number of atomic units of contents (e.g., slides, designs for computer-aided design files, pictures for an album content item, etc.).

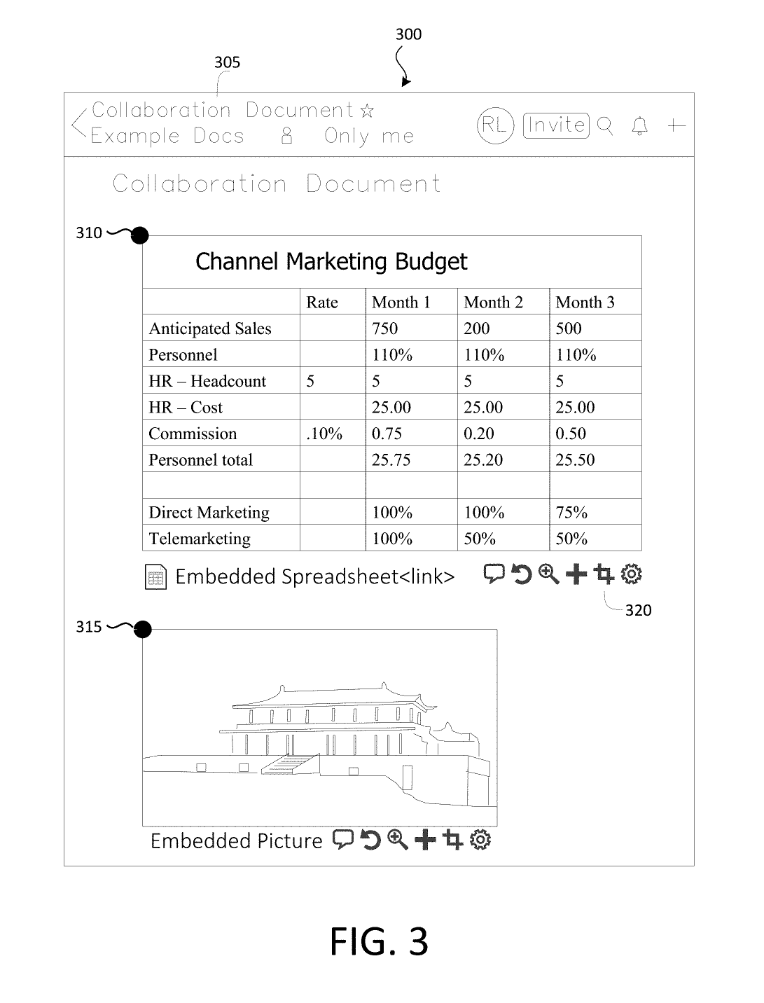

FIGS. 3-5 show example graphical user interfaces that help to illustrate various embodiments of the subject technology. The graphical user interface 300, 400, and 500 may be provided by a client application (e.g., a web browser or native application) running on a client device. The client application may be configured to interface with the content management system to retrieve and display a content item stored or managed by the content management system or by the client device. In FIGS. 3-5, the content item is in the form of collaborative content item 305. However, other types of content items (e.g., other types of files) may also be presented to the user.

The graphical user interface 300 of FIG. 3 shows content from two source content items embedded in collaborative content item 305. More specifically, spreadsheet 310 and image 315 are embedded in collaborative content item 305. The view illustrated in FIG. 3 may be as a result of a user selecting a source content item corresponding to spreadsheet 310 and embedding the source content item into collaborative content item 305 using various interface elements provided by the graphical user interface 300. For example, the user may have embedded spreadsheet 310 by using the URL for the spreadsheet 310. In some scenarios, the spreadsheet 310 may be another content item stored or managed by the content management system and the URL for the spreadsheet 310 may be a URL generated and provided by the content management system. Image 310 may be also be embedded by a user selecting the source content item corresponding to image 310 using a URL and/or a file choosing interface. In other scenarios, the view illustrated in FIG. 3 may be a result of a previous process where the user customized and selected which portions of embedded content items 310 and 315 are to be shown in collaborative content item 305.

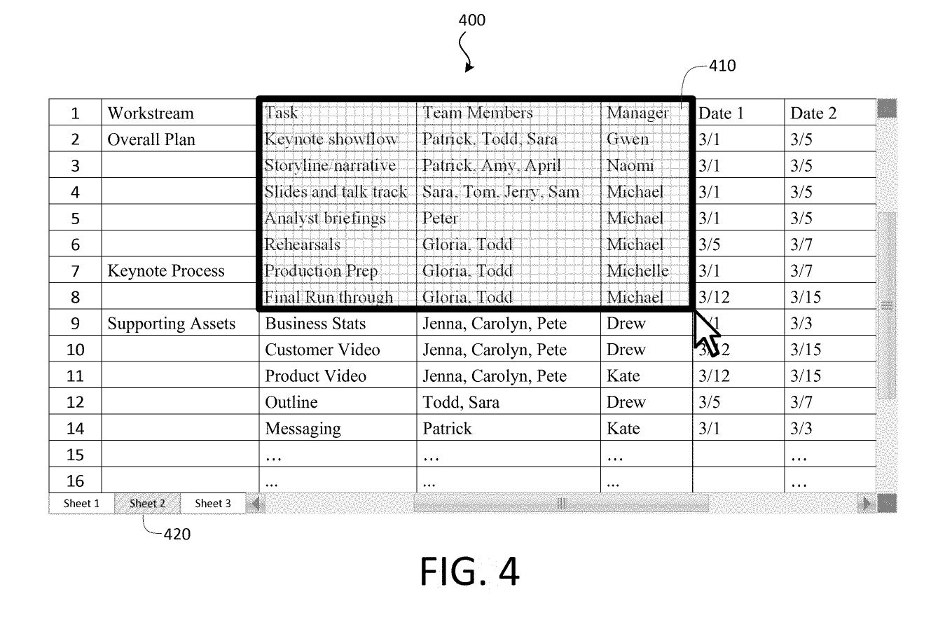

Graphical user interface 300 may also include an interface element 320 that enables the user to select or reselect which portions of spreadsheet content item 310 is to be shown in collaborative content item 305. For example, a user selection of interface element 320 in graphical user interface 300 may cause graphical user interface 400 in FIG. 4 to be displayed.

Graphical user interface 400 of FIG. 4 may be displayed in the same pane, frame, or location that spreadsheet 310 was displayed in collaborative content item 305 in FIG. 3 or in a separate window (e.g., a pop-up window). Graphical user interface 400 may allow the user to navigate through the entirety of the source content item (e.g., spreadsheet content item 310) and select a portion 410 of the source content item to display. For example, the user may navigate to a different sheet 420 in spreadsheet content item 310 than the sheet shown in FIG. 3 and select the portion 410 of the spreadsheet shown in FIG. 4.

Spreadsheet content item 310 may include a number of cells that organized into rows and columns that may be represented by numbers, letters, names, or other identifiers. Each cell in spreadsheet content item 310 may be associated with coordinates within the spreadsheet. The coordinates for a cell may include a row identifier and a column identifier. Accordingly, each cell of spreadsheet content item 310 may be referred using the row identifier and column identifier corresponding to the cell. The content included within the cells may include any type of data such as, for example, text data, image data, audio data, video data, URLs, structured data, unstructured data, and the like. The cells may also include additional elements that may be visible (e.g., buttons, switches, dials, or other interactive elements), that may be invisible (e.g., metadata, formulas, executable files, binary files, placeholder files, etc.), or that may be related to formatting (e.g., cell height or width information, cell background color, text color, font type, template or style information, etc.).

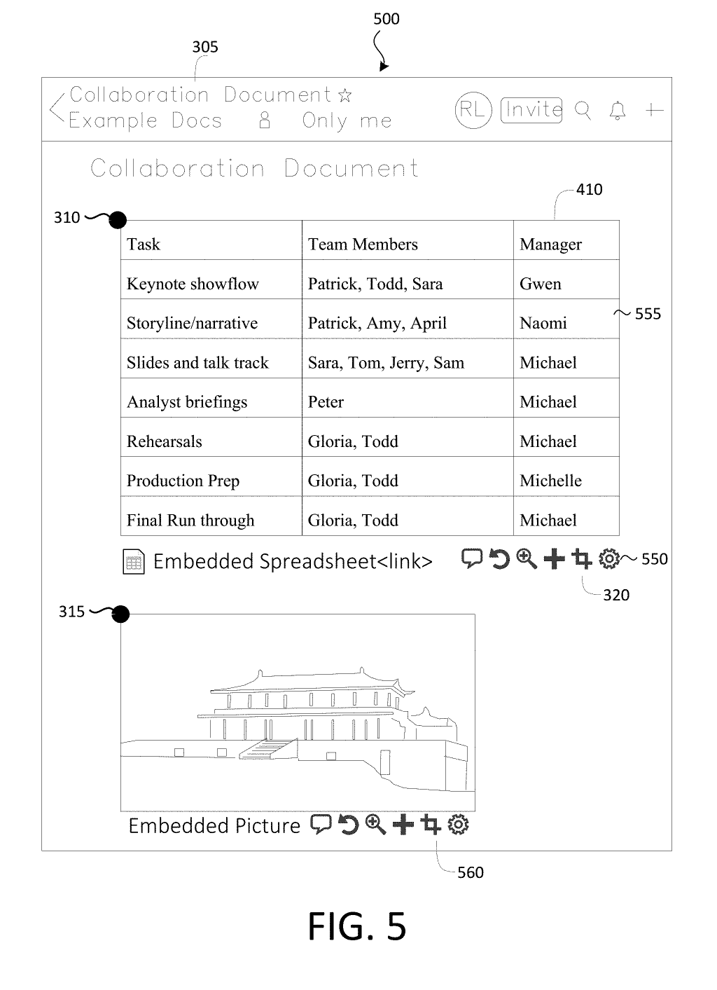

Using graphical user interface 400, a user may select a portion 410 of spreadsheet content item 310 to display. The portion may be defined by cell coordinates for one or more cells (e.g., coordinates for selected cells or a coordinates for a first cell and a last cell that represent a boundary the selected cells) or some other selection of cells in the spreadsheet content item 310. A user selection of the portion 410 of spreadsheet content item 310 may cause graphical user interface 500 in FIG. 5 to be displayed.

As seen in FIG. 5, graphical user interface 500 is shown with spreadsheet content item 310 embedded in collaborative content item 305. However, the portion displayed in collaborative content item 305 corresponds to the user selected portion 410 of spreadsheet content item 310. The user may further refine or change the portion 410 of the embedded spreadsheet content item 310 displayed in collaborative content item using, for example, interface element 320 in graphical user interface 500, which may again cause graphical user interface 400 in FIG. 4 to be displayed.

As discussed above, a selected portion that is displayed in a collaborative content item may be associated with a source content item (e.g., a spreadsheet content item). As discussed above, the source content item may be a content item that is stored or managed by the content management system. In some cases, the source content item may be shared across multiple client devices and/or accessible by multiple different users. When the user (or another user) makes changes to a source content item, these changes may occur in or affect the portion of the source content item that is displayed in the collaborative content item.

For example, in FIG. 5, selected portion 410 of the source content item (e.g., spreadsheet content item 310) that is displayed in the collaborative content item 305 may be edited by the user or another user with authorization to view and edit the source content item. The edits may be in the cells shown in selected portion 410 of spreadsheet content item 310 or in another location that cells shown in selected portion 410 depend from, thus causing the cells in selected portion 410 to be updated.

According to some embodiments, edits or changes to the source content item may be propagated to the portion of the source content item that is embedded in a collaborative content item. For example, if the cells in the source content item that correspond to the selected portion 410 displayed in graphical user interface 500 are updated, the updates would be propagated to the selected portion 410 that is embedded in collaborative content item 305. According to some embodiments, the embedded portions of source content items may be refreshed periodically or refreshed when the collaborative content item is loaded into a graphical user interface by the client application (e.g., a web browser or native application) running on the client device.

According to other embodiments, the embedded portions of source content items may be refreshed upon update of the underlying source content items. For example, the content management system may monitor and track changes to source content items that are stored or managed by the content management system. When a source content item is altered, updated, or otherwise changed, the content management system may transmit an update notification to user accounts with access to collaborative content items that have the updated source content item embedded within. Accordingly, when the client application associated with a user account with access to one of these collaborative content items receives the update notification, the client application refresh the portion of the source content item embedded in the collaborative content item. For example, the client application may request an updated version of the source content item or the portion of the source content item and use the updated version to render the portion of the source content item in the collaborative content item.

By propagating changes to a source content item to a collaborative content item that embeds the source content item or portions of it, users viewing the collaborative content item may see current data that is up-to-date instead of stale data. Additionally, there is less ambiguity of which version of the source content item or how up-to-date the embedded portion of the source content item is. Instead, the embedded portion of the source content item should substantially correspond to the latest version of the source content item.

In some cases, having the embedded portion of a source content item be updated over time may be a desirable result or an undesirable result. For example, some users may wish to display the embedded portion as a snapshot in time. Accordingly, the graphical user interface 500 in FIG. 5 may include an interface element 550 that allows a user to enable or disable this updating feature. In some embodiments, the interface element 550 may allow a user to select a version (from the multiple versions tracked by the content management system) of a source content item to display. Additional information regarding the version or time the embedded portion was last updated may be provided to help users distinguish the embedded portion displayed in the collaborative content item from other versions of the source content item.

Various embodiments of the subject technology may also allow users to make changes in the source content item (e.g., spreadsheet content item 310) embedded in collaborative content item 305 via the graphical user interface 500 displaying collaborative content item 305. These changes may be propagated to the source content item managed by the content management system.

For example, a user may update cell 555 in the spreadsheet content item 310 via the graphical user interface 500. The client application may notify the content management system of the update to cell 555 of the spreadsheet content item 310. The notification may include a reference to the location (e.g., the cell column number and row number or a range of affected rows and columns). In some embodiments, the notification may further include update data needed by the content management system to apply the update to other versions of the spreadsheet content item 310 managed by the content management system. In other embodiments, the content management system, may retrieve the update data from the client application via other synchronization protocols after receiving the notification. Once the update data is received by the content management system, the content management system may apply the update to the spreadsheet content item 310.

Similarly, for other types of content items (e.g., images, videos, slide decks, audio files, documents, etc.) The client application may transmit a notification of an update to the content item to the content management system. The notification may include an identifier for the content item and, in some embodiments, location data associated with the update. In response, the content management system may retrieve update data and apply the update to the content item. Accordingly, a user may changes to an embedded source content item without having to separately open the source content item and make the change. This may increase user satisfaction and make user workflow more efficient.

In some cases, having changes to the embedded portion of a source content item be propagated to the underlying source content item may be a desirable result or an undesirable result. For example, a user may wish to make a change to the embedded portion locally without having the change be propagated to the underlying source content item. Accordingly, the graphical user interface 500 in FIG. 5 may include an interface element 550 that allows a user to enable or disable this feature. Additional warnings or notifications may be displayed to inform users whether the feature is enabled or disabled.

Although the example graphical user interfaces shown in FIGS. 3-5 illustrate a spreadsheet content item as a source of content for embedding in a collaborative content item and a user selection of a portion of the spreadsheet content item to be displayed in the collaborative content item, similar concepts may be applied to other types of content items. For example, a user may determine that a portion of image content item 315 is of particular interest. Accordingly, the user may use interface element 560 in FIG. 5 to crop image content item 315 and make a user selection a portion of the embedded image content item that is of interest. This selected portion of embedded image content item 315 will be displayed in collaborative content item 305. In some cases, multiple portions may be selected and the selected portions may be displayed in the collaborative content item 305 as a collage or in subpanels.

In other embodiments, the user selection of the portion of a source content item to be displayed in a collaborative content item may be a set of one or more slides in a slide deck content item or presentation content item, a selection of pages in a document content item, a selection of files in an archive content item, a clip (e.g., a portion defined by a start time and an end time) of an audio or video content item, etc. The collaborative content item may be configured to support a large number of different types of content and a user may be able to select a portion of interest of an embedded content item for display in the collaborative content item. Accordingly, portions of embedded content items that are not particularly interesting or relevant may not be displayed in the collaborative content item while portions of particular relevance or interest may be displayed. This allows the collaborative content item to be more densely packed with relevant content, increases the efficiency of the use of space in the collaborative content item, and increases the efficacy of conveying information in the collaborative content item.

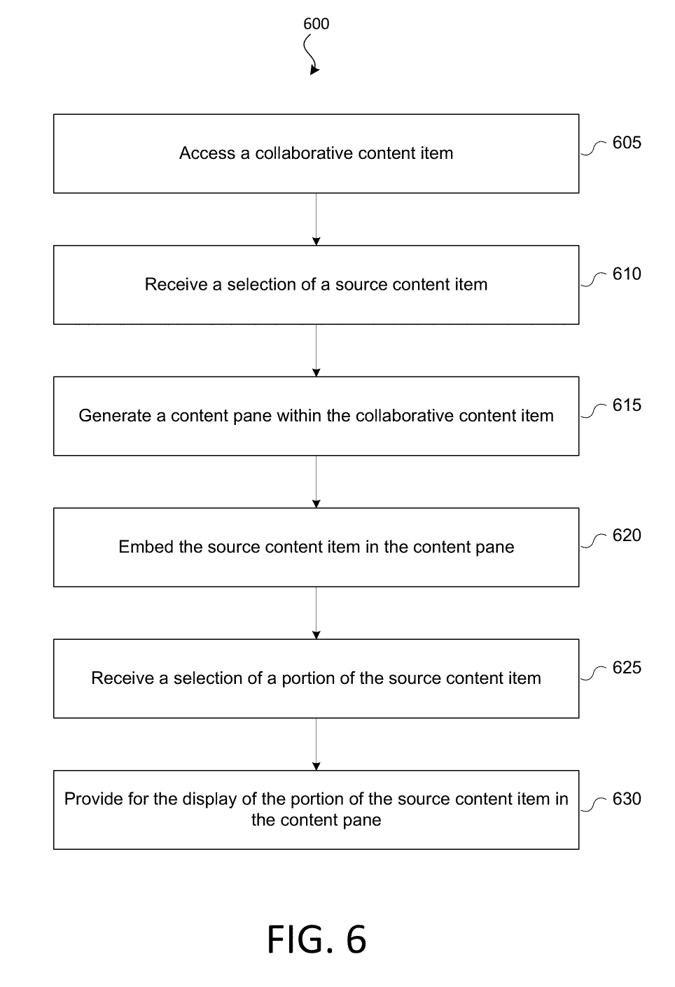

FIG. 6 illustrates an example method for embedding a portion of a source content item in a collaborative content item, in accordance with various embodiments of the subject technology. Although the methods and processes described herein may be shown with certain steps and operations in a particular order, additional, fewer, or alternative steps and operations performed in similar or alternative orders, or in parallel, are within the scope of various embodiments unless otherwise stated. The method 600 may be implemented by computing device such as, for example, a client device.

As described above, a content management system may store and manage a number of collaborative content items. Each collaborative content item may be shared among one or more user accounts. For example, a client device running a client application associated with a user account may request a collaborative content item from the content management system. The content management system may receive the request, determine that the user account is permitted to access the collaborative content item, retrieve the collaborative content item, and transmit the collaborative content item to the client application running on the client device. In some embodiments, the client device may store the received collaborative content item and keep a separate version for local access. The collaborative content item stored at the client device and the version of the collaborative content item stored by the content management system may be kept in sync by the client application working in conjunction with the content management system. A user may, using the client device may select and open the collaborative content item for viewing.

At operation 605, the client device may access the collaborative content item and render the collaborative content item in a graphical user interface. In some cases, the collaborative content item may include one or more previously embedded content items. As the client device renders the collaborative content item, the embedded content items may be requested and retrieved from the content management system and rendered accordingly. Alternatively, the client application may create a new collaborative content item that is rendered in the graphical user interface.

The graphical user interface of the client application running on the client device may enable various features with respect to a collaborative content item. For example, at operation 610, the client device may receive a user selection of a source content item. The graphical user interface may enable a user to select a source content item for embedding into a collaborative content item. The client application may provide a file chooser interface that interfaces with the content management system and allows a user to select a source content item managed by the content management system. Alternatively, the graphical user interface may allow for a user to provide a URL for a source content item managed by the content management system.

Once the user has selected a source content item, the client application may send a request for the selected source content item to the content management system. The content management system may retrieve the selected source content item and transmit the source content item to the client device.

At operation 615, the client device may generate a content pane within the collaborative content item and, at operation 620, embed the source content item that is received from the content management system in the content pane. As discussed with respect to FIGS. 3-5, the graphical user interface displayed on the client device may allow for a user to select a portion of the source content item to be displayed in the content pane of the collaborative content item. Accordingly, at operation 625, the client device may receive a selection of a portion of the source content item and, at operation 630, provide for the display of the portion of the source content item in the content pane of the collaborative content item. For example, the client device may encode in the content pane of the collaborative content item a reference to the source content item as well as location data corresponding to the selected portion of the source content item and/or identifiers corresponding to the selected portion of the source content item.

The location data may vary depending on a content item type that corresponds to the source content item. For example, in a spreadsheet type of content item, the location data may include one or more cell identifiers which specify one or more locations in the source content item. The cell identifiers may include a selection or range of cells, rows, columns, sheets in the spreadsheet, or a combination thereof. For an image or video type of content item, the location data may include pixel locations, coordinates, or ranges that define a location of a portion of the content item. For a video and/or audio type of content item, location data may include a selected start time and stop time that specifies a location of a clip or portion in the content item that is of interest.

Some content item types may be composed of a number of atomic units. Accordingly, the location data for some content item types may include a selection of atomic units. For example, location data for a slideshow, slide deck, or presentation type of content item may include a selection of one or more slides and/or slide ranges. Location data for a picture album type of content item may include a selection or range of pictures in the album. Location data for a document type of content item may include a selection and/or range of pages or chapters of the document.

In some cases, the collaborative content item may be shared amongst multiple users and/or client devices and multiple copies or versions of the collaborative content items may exist. The content management system, in cooperation with client applications on client devices, may be configured to keep the versions of the collaborative content item in sync with one another. According to some embodiments, the embedding of the source content item in the collaborative content item and/or the selection and display of the selected portion of the source content item within the collaborative content item is a change to the collaborative content item. In order to help maintain synchronization of the collaborative content item, the client device may transmit the changes or the changed version of the collaborative content item (e.g., the collaborative content item with the embedded portion of the source content item) to the content management system. The content management system may manage the dissemination and updating of other versions of the collaborative content item.

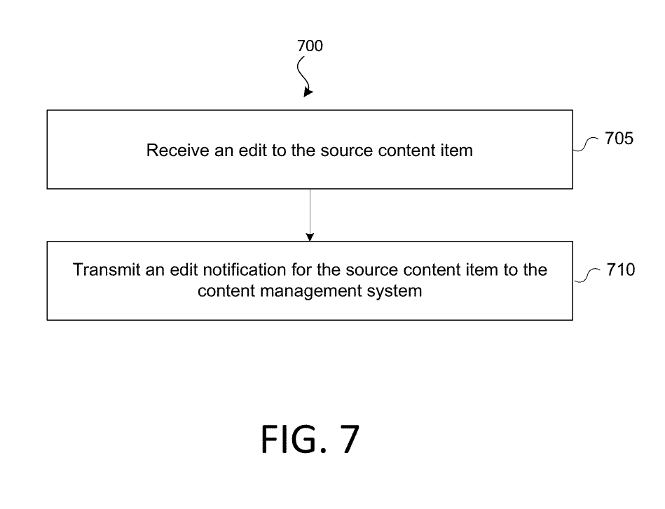

FIG. 7 illustrates an example method for editing a source content item embedded in a collaborative content item, in accordance with various embodiments of the subject technology. Although the methods and processes described herein may be shown with certain steps and operations in a particular order, additional, fewer, or alternative steps and operations performed in similar or alternative orders, or in parallel, are within the scope of various embodiments unless otherwise stated. The method 700 may be implemented by computing device such as, for example, a client device.

The portion of a source content item displayed in a content pane of a collaborative content item, in some embodiments, may be edited by a user via the content pane displayed in the collaborative content item. For example, the graphical user interface displayed on the client device may allow for a user to navigate the portion of the source content item displayed or the entire source content item through and make edits, additions, deletions, or any other changes to the source content item.

At operation 705, the client device may receive an edit to the source content item embedded in the collaborative content item via the graphical user interface and transmit an edit notification for the source content item to the content management system at operation 710. The edit notification may include an identifier to the source content item and include information related to the edit that the content management system may use to apply the edit to the version(s) of the source content item stored or managed by the content management system. After the content management system applies the edit, the version(s) of the source content item stored or managed by the content management system and the source content item embedded in the collaborative content item displayed in the graphical user interface at the client device are in sync.

In some cases, if other client devices also store a version of the collaborative content item and/or the source content item, the content management system may transmit an update notification to the other client devices informing them of the edit to the source content item. The update notification may include an identifier to the source content item and/or an identifier to the collaborative content item. In response to receiving the update notification, the other client devices may request the updated version of the source content item from the content management system. After the content management system transmits the update to the other client devices and the other client devices update their version of the source content item and/or their version of the collaborative content item, all versions of the source content item and/or the collaborative content item should be in sync.

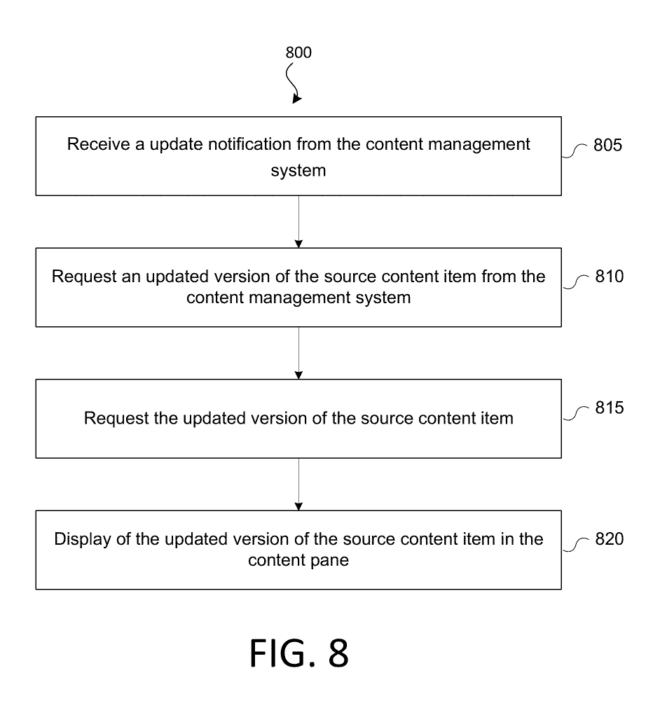

FIG. 8 illustrates an example method for updating a source content item embedded in a collaborative content item, in accordance with various embodiments of the subject technology. Although the methods and processes described herein may be shown with certain steps and operations in a particular order, additional, fewer, or alternative steps and operations performed in similar or alternative orders, or in parallel, are within the scope of various embodiments unless otherwise stated. The method 800 may be implemented by computing device such as, for example, a client device.

As discussed above, content management system is configured to manage content items across a number of client devices, allow sharing and editing of these content items, and enable the synchronization of these content items. A user on a client device may make changes to a source content item either directly or through a content item that the source content item is embedded within. The client device may notify and transmit the changes to the content management system for synchronization. The content management system receives the changes and applies the changes to the version of the source content item stored by the content management system. However, there may be additional versions of the source content item stored locally at other client devices that have not yet been synchronized based on the changes. Accordingly, the content management system may transmit an update notification to the other client devices that may have access to or have locally stored the source content item or any collaborative content items where the source content items are embedded within. The update notification may include an identifier for the source content item that was edited.

At operation 805, a client device may receive the update notification from the content management system. Based on the identifier for the source content item, the client device may determine that the locally stored version of the source content item is no longer in sync with other versions of the source content item. Accordingly, at operation 810, the client device may request an updated version of the source content item from the content management system. The content management system receives the request and transmits the updated version of the source content item to the client device. The updated version may be the entire source content item, one or more portions of the source content item that were updated, or a list of changes that the client device may use to update the source content item. At operation 815, the client device may receive the updated version of the source content item and display the updated version of the source content item in a content pane of a collaborative content item at operation 820.

In some cases, only a portion of the source content item is displayed when the source content item is embedded in a collaborative content item. Accordingly, in some embodiments, the client device may determine whether the changes to the source content item are associated with the portion of the source content item displayed in the collaborative content item. If so, the client device can perform one or more of the operations of method 800. Otherwise, one or more of the operations of method 800 may not be necessary.

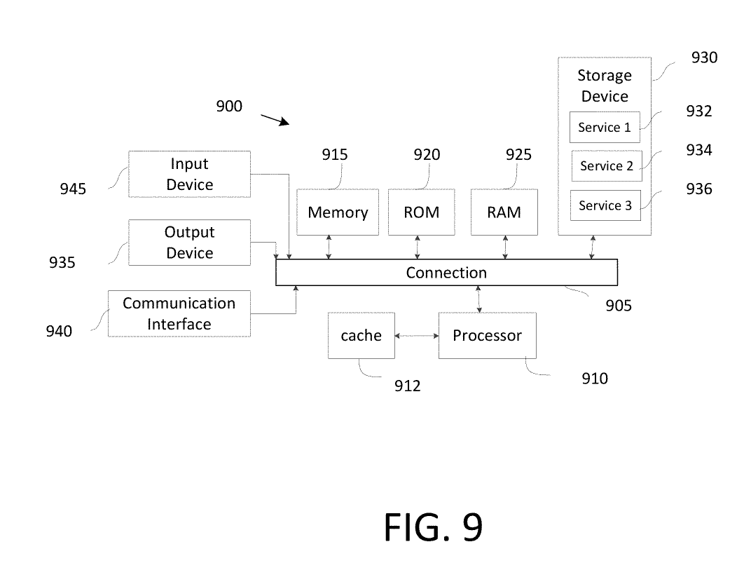

FIG. 9 shows an example of computing system 900 in which the components of the system are in communication with each other using connection 905. Connection 905 can be a physical connection via a bus, or a direct connection into processor 910, such as in chipset architecture. Connection 905 can also be a virtual connection, networked connection, or logical connection.

In some embodiments computing system 900 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 900 includes at least one processing unit (CPU or processor) 910 and connection 905 that couples various system components including system memory 915, such as read only memory (ROM) and random access memory (RAM) to processor 910. Computing system 900 can include a cache of high-speed memory connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms known to those of skill in the art. In some instances, multimodal systems can enable a user to provide multiple types of input/output to communicate with computing system 900. Computing system 900 can include communications interface 940, which can generally govern and manage the user input and system output. There is no restriction on operating on any particular hardware arrangement and therefore the basic features here may easily be substituted for improved hardware or firmware arrangements as they are developed.

Storage device 930 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 930 can include software services, servers, services, etc., that when the code that defines such software is executed by the processor 910, it causes the system to perform a function. In some embodiments, a hardware service that performs a particular function can include the software component stored in a computer-readable medium in connection with the necessary hardware components, such as processor 910, connection 905, output device 935, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware, and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A computer-implemented method comprising:
receiving a user selection of a portion of a source content item to embed into a collaborative content item, wherein the source content item is managed by a content management system and the portion of the source content item is defined by location data within the source content item;
generating a content pane within the collaborative content item;
embedding the portion of the source content item in the content pane of the collaborative content item;
receiving, from the content management system, an edit to the source content item, wherein the edit is to the portion of the source content item embedded in the collaborative content item;
determining, for the collaborative content item, that updating of the collaborative content item is enabled for the edit to the source content item; and
updating, based on the edit to the source content item and enablement of updating for the edit to the source content item, the portion of the source content item embedded in the collaborative content item.

2. The computer-implemented method of claim 1, wherein the source content item and the collaborative content item are stored by the content management system.

3. The computer-implemented method of claim 1, further comprising notifying the content management system of the embedding of the portion of the source content item in the collaborative content item, wherein the content management system is configured to update the collaborative content item with the embedding of the portion of the source content item.

4. The computer-implemented method of claim 1, further comprising:
accessing the collaborative content item stored by the content management system;
displaying the collaborative content item in a graphical user interface;
receiving, via the graphical user interface, a user selection of the source content item for embedding; and
providing for the display of the source content item within the collaborative content item.

5. The computer-implemented method of claim 1, wherein the user selection of the portion of the source content item is received via the content pane.

6. The computer-implemented method of claim 1, wherein the source content item is a spreadsheet content item and the location data is a set of cells in the spreadsheet content item.

7. The computer-implemented method of claim 1, wherein the source content item is a slide deck content item and the location data is a set of slides in the slide deck content item.

8. The computer-implemented method of claim 1, wherein the embedding of the portion of the source content item in the content pane of the collaborative content item is performed by a first client device associated with a first user account and wherein the edit to the source content item is associated with a second client device associated with a second user account of the content management system.

9. The computer-implemented method of claim 1, wherein the embedding of the portion of the source content item in the content pane of the collaborative content item is performed by a first client device associated with a user account and wherein the edit to the source content item is associated with a second client device associated with the user account.

10. The computer-implemented method of claim 1, further comprising:
receiving, via the content pane, a user edit to the source content item embedded in the collaborative content item; and
transmitting, to the content management system, an edit notification for the source content item.

11. A non-transitory computer readable medium comprising instructions, the instructions, when executed by a computing system, cause the computing system to:
access a collaborative content item stored by a content management system;
receive a user selection of a portion of a source content item to embed into the collaborative content item, wherein the source content item is managed by the content management system;
generate a content pane within the collaborative content item; and
embed the portion of the source content item in the content pane of the collaborative content item; and
determine, for the collaborative content item, that updating of the collaborative content item is enabled in association with changes to the source content item.

12. The non-transitory computer readable medium of claim 11, wherein the instructions further cause the computing system to:
receive, from the content management system, an edit to the source content item, wherein the edit is to the portion of the source content item embedded in the collaborative content item; and
update, based on the edit to the source content item and enablement of updating for the edit to the source content item, the portion of the source content item embedded in the collaborative content item.

13. The non-transitory computer readable medium of claim 11, wherein the instructions further cause the computing system to:
transmit, to the content management system, a notification for embedding of the portion of the source content the collaborative content item.

14. The non-transitory computer readable medium of claim 11, wherein the instructions further cause the computing system to:
receive, via a graphical user interface, a user selection of the source content item for embedding; and
provide for display of the source content item within the collaborative content item.

15. A system comprising:
a processor; and
a non-transitory computer-readable medium storing instructions that, when executed by the processor, cause the processor to:
receive a user selection of a portion of a source content item to embed into a collaborative content item, wherein the source content item is managed by a content management system;
generate a content pane within the collaborative content item;
embed the portion of the source content item in the content pane of the collaborative content item;
determine, for the collaborative content item, that updating of the collaborative content item is enabled in association with changes to the source content item;
receive, via the content pane, a user edit to the source content item, wherein the update is to the portion of the source content item embedded in the collaborative content item; and
transmit, to the content management system based on the user edit to the source content item, an update for the portion of the source content item.

16. The system of claim 15, wherein the instructions further cause the processor to:
receive, from the content management system, an edit to the source content item, wherein the update is to the portion of the source content item embedded in the collaborative content item; and
update, based on the edit to the source content item and enablement of updating for the edit to the source content item, the portion of the source content item embedded in the collaborative content item.

17. The system of claim 15, wherein the instructions further cause the processor to:
transmit, to the content management system based on the portion of the source content item embedded in the collaborative content item, an update for the collaborative content item.

18. The system of claim 15, wherein the instructions further cause the processor to:
access the collaborative content item stored by the content management system;
display the collaborative content item in a graphical user interface;
receive, via the graphical user interface, a user selection of the source content item for embedding; and
provide for the display of the source content item within the collaborative content item.

19. The system of claim 15, wherein the user selection of the portion of the source content item is received via the content pane.

20. The system of claim 15, wherein the source content item is composed of a plurality of atomic units and the user selection of the portion of the source content item is a selection of at least one unit of the plurality of atomic units.
